(19) United States
(12) Patent Application Publication
(10) Pub. No.: US 2014/0021881 A1
(43) Pub. Date: Jan. 23, 2014

(54) MARKING DEVICE AND MARKING SYSTEM

(71) Applicant: TOSHIBA LIGHTING & TECHNOLOGY CORPORATION, Kanagawa (JP)

(72) Inventor: Yasufumi ISHIDA, Kanagawa (JP)

(73) Assignee: Toshiba Lighting & Technology Corporation, Kanagawa (JP)

(21) Appl. No.: 13/790,598

(22) Filed: Mar. 8, 2013

(30) Foreign Application Priority Data
Jul. 20, 2012 (JP) 2012-161074

(51) Int. Cl. H05B 33/08

(52) U.S. Cl. CPC H05B 33/0839
USPC 315/210

(57) ABSTRACT

A marking device includes a solid-state light-emitting element as a light source. A plurality of the marking devices are arranged spaced apart from one another, wherein the solid-state light-emitting element is subjected to PWM control and lit at a frequency of 100 Hz to 200 Hz or exceeding 2,000 Hz.

### INCORPORATION BY REFERENCE

The present invention claims priority under 35 U.S.C. §119 to Japanese Patent Application No. 2012-161074 filed on Jul. 20, 2012. The content of the application is incorporated herein by reference in their entirety.

### FIELD

Embodiments described herein relate generally to a marking device that subjects a solid-state light-emitting element to PWM control and lights the solid-state light-emitting element.

### BACKGROUND

In recent years, as a grounded or embedded marking device in an airport, a marking device employing a solid-state light-emitting element such as a light-emitting diode as a light source has been proposed. In such a marking device, the brightness of a marker lamp needs to be changed according to an ambient environment. Therefore, it is known that the solid-state light-emitting element is subjected to PWM (Pulse Width Modulation) control and lit.

However, if a viewer (a user) moves a visual point along an array direction of a plurality of marker lamps while directly viewing the plurality of marker lamps, the viewer sometimes feels as if the solid-state light-emitting element is intermittently lit. Therefore, the viewer feels a sense of discomfort and mental stress.

It is presumed that a cause of this phenomenon is a phenomenon similar to a strobe effect. According to a relation between a blinking period of solid-state light-emitting elements in a plurality of marking devices lit by PWM control and shifting speed of the visual point of the viewer shifted by, for example, turning the neck, the phenomenon similar to the strobe effect is caused when a lighting period and an extinguishing period of the solid-state light-emitting elements enter a visual field.

Further, the solid-state light-emitting element has a sharp rising edge during lighting of an optical output and a sharp falling edge during extinction of the optical output compared with other light sources. It can be presumed that this also relates to the phenomenon.

As a luminaire in a television studio or the like, there is proposed a luminaire in which a light-emitting diode functioning as a light source is subjected to PWM control and lit at a frequency equal to or higher than 4.5 kHz such that the influence on flickering of a video of a television camera decreases. The luminaire mainly illuminates an object and takes into account the influence on a video of the television camera caused when the object is illuminated. The luminaire does not take into account the problems caused when the viewer moves a line of sight, for example, when the viewer looks around a plurality of marker lamps.

### DESCRIPTION OF THE DRAWINGS

FIG. 1 is a circuit diagram of a marking device according to an embodiment;

FIG. 2 is a waveform chart showing an example of PWM control by the marking device;

FIG. 3 is a schematic diagram showing a test state;

FIG. 4 is a table showing a test result;

FIG. 5 is a graph showing the test result; and

FIG. 6 is a perspective view of a marking system.

### DETAILED DESCRIPTION

According to an embodiment, there is provided a marking device including a solid-state light-emitting element as a light source, a plurality of the marking devices being arranged spaced apart from one another. The solid-state light-emitting element is subjected to PWM control and lit at a frequency of 100 Hz to 200 Hz or exceeding 2,000 Hz.

The marking device is a device for allowing a viewer (a user) to directly see an optical output of the device and recognize a marking content. The marking device is, for example, an embedded or grounded marker lamp set in a runway, a taxiway, and the like in an airport. Viewers in this case are pilots, passengers, and the like. The marking device is, for example, an electronic display device such as a scoreboard set in a stadium. Viewers in this case are spectators, athletes, and the like. Further, the marking device may be a marking device used for other purposes such as an advertisement, a signboard, a traffic light, and the like. In short, the marking device is arranged such that a plurality of the solid-state light-emitting elements sequentially enter the visual field of the viewer when, for example, the viewer turns the neck (shakes the head). Therefore, a distance of mutual separation of the marking devices changes according to a purpose, a distance to the viewer, and the like.

The solid-state light-emitting element is representatively a light-emitting diode. However, the solid-state light-emitting element may be other light-emitting elements such as a semiconductor laser, an organic EL element, and the like. The number of solid-state light-emitting elements used in one marking device is one or more and may be any number.

According to this embodiment, a frequency for subjecting the solid-state light-emitting element to the PWM control is specified as a frequency of 100 Hz to 200 Hz or exceeding 2,000 Hz. Therefore, even if the viewer moves the line of sight and visually recognizes the plurality of marking devices, it is possible to eliminate a sense of discomfort in which the solid-state light-emitting element is intermittently lit or reduce a degree of the sense of discomfort.

An embodiment is explained below with reference to the drawings.

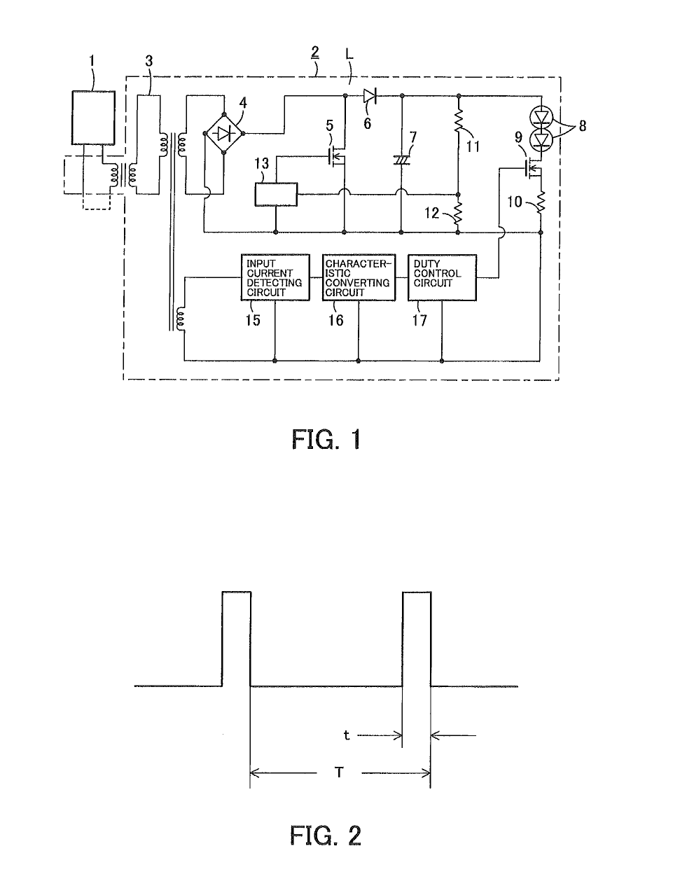

In FIG. 1, a marking system employing a marking device such as an embedded or grounded marker lamp for an airport is shown. Reference numeral 1 denotes an alternating constant current power supply device. A plurality of marking devices 2 (in FIG. 1, only one marking device 2 is shown) are connected to the alternating constant current power supply device 1 in series. For example, as shown in FIG. 6, the plurality of marking devices 2 are arrayed on the road surface of a runway, a taxiway, or the like in the airport while being spaced apart from one another along a linear or curved array direction. That is, the plurality of marking devices 2 are arranged spaced apart from one another to enable a viewer to visually recognize the marking devices 2 while shifting the line of sight.

The alternating constant current power supply device 1 can switch an output current value in a plurality of stages, for example, five stages. The switching of the output current value is performed by, for example, phase control means. However, the switching may be performed by amplitude variable means or the like for a sine wave alternating-current voltage.

The marking device 2 includes a saturable isolation transformer 3 and a lighting circuit L connected to one output of the isolation transformer 3. The lighting circuit L includes a rectifier 4 configured to rectify the one output of the isolation transformer 3. A switching element 5 is connected between output ends of the rectifier 4. A series circuit of a diode 6 for backflow prevention and a smoothing capacitor 7 is connected to the switching element 5 in parallel.

A plurality of light-emitting diodes functioning as solid-state light-emitting elements 8 are connected in series on an output side of the capacitor 7 together with a switching element 9 for PWM control and a resistor 10 for current limitation.

Resistors 11 and 12 functioning as voltage detecting circuits are connected to the capacitor 7 in parallel. A detection signal of the voltage detecting circuit is input to a control section 13 of the switching element 5. The control section 13 subjects ON and OFF of the switching element 5 to, for example, PWM control such that a voltage of the capacitor 7 is fixed.

The other output of the isolation transformer 3 is input to an input current detecting circuit 15. The input current detecting circuit 15 detects at which stage of the five stages of an output current of the alternating constant current power supply device 1 is.

A detection output of the input current detecting circuit 15 is input to a characteristic converting circuit 16. The characteristic converting circuit 16 stores in advance information concerning what brightness an optical output of the solid-state light-emitting elements 8 should be set to for each stage of the five stages. The characteristic converting circuit 16 outputs the stored information to a duty control circuit 17 functioning as controlling means.

The duty control circuit 17 subjects the switching element 9 to PWM control according to the input stored information. For example, as shown in FIG. 2, the duty control circuit 17 controls the switching element 9 to be turned on in a period t in one cycle T and to be turned off in a period (T-t).

A test concerning vision of the marking device 2 is explained.

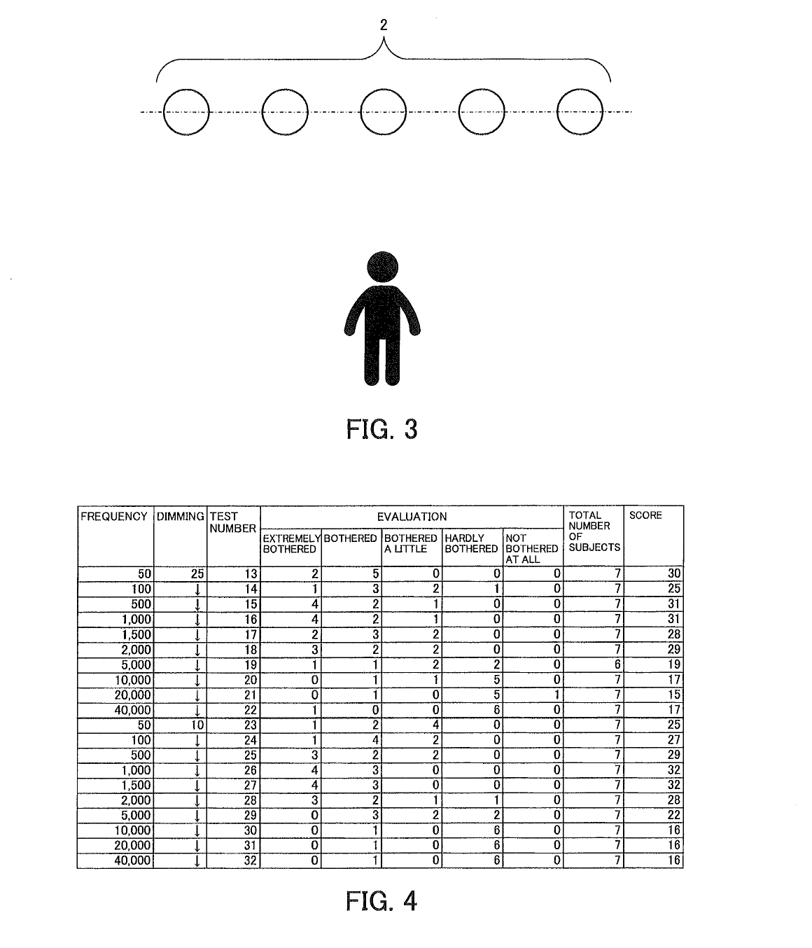

FIG. 3 is a schematic diagram showing a test situation. As shown in FIG. 3, in the test, a plurality of marking devices 2 were set at an interval of about 1 m and a subject (a viewer) shifted the line of sight in the left or right direction to look around the marking devices 2 at a point at least about 6.7 m apart from the marking devices 2. Vision of the marking devices 2 was evaluated. In FIG. 3, the marking devices 2 are a marker lamp model for airport that outputs light in a direction of an alternate long and short dash line in FIG. 3. The subject sees the light of the marker lamp model for airport from an oblique direction. Actual dimensions of a state of use in an airport are reduced to 1/15. Shifting speed for the line of sight is usually neck turning speed of a person. The shifting speed was set to, for example, speed for shifting the line of sight 120° within one second. A frequency for PWM control was changed from 50 Hz to 40,000 Hz. A dimming level was set to 10% (on-duty t/T was about 10%) or 25% (the on-duty was about 25%).

When a frequency for subjecting the solid-state light-emitting elements 8 of the marking devices 2 to the PWM control was changed between 50 Hz and 40,000 Hz, vision for seven subjects (only in a part of the test, six subjects) was evaluated.

A result of the test is shown in FIG. 4. In FIG. 4, a frequency of the PWM control, a dimming level, and a test number is shown in the longitudinal row and the number of subjects for each evaluation, a total number of subjects, and a total of scores are shown in the lateral row. Evaluations include “extremely bothered”, “bothered”, “bothered a little”, “hardly bothered”, and “not bothered at all”. Scores are 5 points for “extremely bothered”, 4 points for “bothered”, 3 points for “bothered a little”, 2 points for “hardly bothered”, and 1 point for “not bothered at all”. A total of scores x number of subjects for each evaluation is shown.

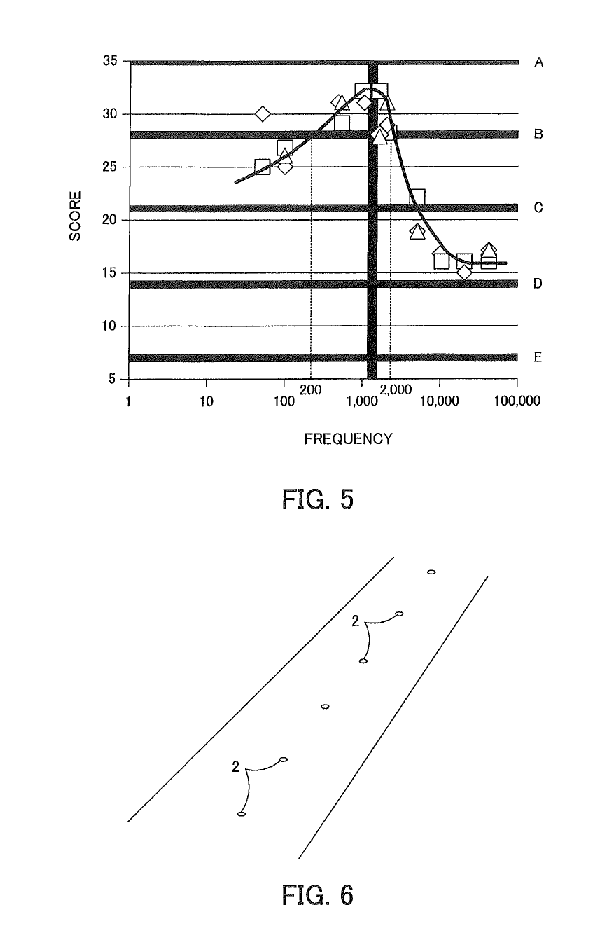

A graph of the test result is shown in FIG. 5. In FIG. 5, diamonds and squares respectively indicate, concerning 25% lighting and 10% lighting, scores of vision obtained when the frequency for the PWM control is sequentially increased as shown in FIG. 4 between 50 Hz and 40,000 Hz. Triangles indicate, concerning 10% lighting, scores of vision obtained when the frequency for the PWM control is changed at random.

In FIG. 5, a line A indicates a maximum total (35 points) line of “extremely bothered (5 points)”, a line B indicates a maximum total (28 points) line of “bothered (4 points)”, a line C indicates a maximum total (21 points) line of “bothered a little (3 points)”, a line D indicates a maximum total (14 points) line of “hardly bothered (2 points)”, and a line E indicates a maximum total (7 points) line of “not bothered at all (1 point)”.

As it is seen from FIG. 5, a score is below the maximum total line B of “bothered” in a domain of a frequency equal to or lower than 200 Hz and a domain of a frequency exceeding 2,000 Hz. In these domains, vision is average but is better than “bothered”. In other domains, most of the subjects feel a sense of discomfort in which the solid-state light-emitting elements 8 are intermittently seen. Frequencies in the domains are improper because it is likely that mental stress is caused.

However, concerning the domain of the frequency equal to or lower than 200 Hz, since it is likely that a problem of flicker occurs in a stationary view state, the frequency for the PWM control needs to be set to a frequency equal to or higher than 100 Hz.

According to the above explanation, to prevent the viewers from feeling the sense of discomfort in which the solid-state light-emitting elements 8 of the marking devices 2 are intermittently seen, it is necessary to set the frequency for the PWM control to a frequency of 100 Hz to 200 Hz or exceeding 2,000 Hz.

In particular, concerning the domain of the frequency exceeding 2,000 Hz, if the frequency for the PWM control is equal to or higher than 5,000 Hz, vision is better than “bothered a little” in average. An upper limit of the frequency for the PWM control is not limited according to vision. However, to accurately perform the PWM control, the upper limit is desirably set to several hundred kilohertz, for example, 100 kHz.

Concerning the dimming level, in the test result, only 10% and 25% are shown. However, the same effects were confirmed in the frequency domains if the on-duty of the PWM control is equal to or lower than 50%. Therefore, this embodiment is effective in the marking device 2 that is likely to be lit at the on-duty equal to or smaller than 50%.

In another embodiment, there is provided a marking system in which the plurality of marking devices 2 including the solid-state light-emitting elements 2 as light sources are respectively arranged spaced apart from one another in a predetermined range in which a viewer can visually recognize the plurality of marking devices 2 while shifting the line of sight and the solid-state light-emitting elements 8 of the marking devices 2 are subjected to the PWM control and lit at the same frequency or approximate frequencies of 100 Hz to 200 Hz or exceeding 2,000 Hz. In this embodiment, the same action and effects as those explained above are attained.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A marking device including a solid-state light-emitting element as a light source, a plurality of the marking devices being arranged spaced apart from one another, wherein the solid-state light-emitting element is subjected to PWM control and lit at a frequency of 100 Hz to 200 Hz or exceeding 2,000 Hz.

2. The device according to claim 1, comprising:
a lighting circuit configured to supply lighting power to the solid-state light-emitting element via a switching element; and
a control section configured to subject the switching element to the PWM control.

3. The device according to claim 1, wherein a desirable domain in the frequency exceeding 2,000 Hz is a frequency equal to or higher than 5,000 Hz.

4. The device according to claim 1, wherein on-duty of the PWM control is equal to or lower than 50%.

5. A marking system in which a plurality of marking devices respectively including solid-state light-emitting elements as light sources are arranged spaced apart from one another, wherein the solid-state light-emitting elements of the plurality of marking devices are subjected to PWM control and lit at a frequency of 100 Hz to 200 Hz or exceeding 2,000 Hz.

6. The system according to claim 5, wherein frequencies for subjecting the solid-state light-emitting elements of the plurality of marking devices to the PWM control are a same frequency or approximate frequencies.

7. The system according to claim 5, wherein the marking devices includes: lighting circuits configured to supply lighting power to the plurality of solid-state light-emitting elements via switching elements; and control sections configured to subject the switching elements to the PWM control.

8. The system according to claim 5, wherein a desirable domain in the frequency exceeding 2,000 Hz is a frequency equal to or higher than 5,000 Hz.

9. The system according to claim 5, wherein on-duty of the PWM control is equal to or lower than 50%.
